(19) United States
(12) Patent Application Publication
(10) Pub. No.: US 2004/0148343 A1
(43) Pub. Date: Jul. 29, 2004

(54) Method and system for a hosted MVNO platform and management

(76) Inventor: Dorron Mottes, Caesarea (IL)

Correspondence Address: DORRON MOTTES, II LEMON ST., P.O. Box 4562, CAESAREA, 38900, IL

(21) Appl. No.: 10/716,699

(22) Filed: Nov. 14, 2003

Related U.S. Application Data
(60) Provisional application No. 60/429,434, filed on Nov. 29, 2002.

(51) Int. Cl. G06F 15/16

(52) U.S. Cl. 709/203; 709/228

(57) ABSTRACT

The present invention relates to a method and system for a hosted MVNO platform and management, which enables a MVNO to provide and market services to their user and potential users, based on a 3^{rd} party virtual network offering which is based on at least one MNO network. The system provides an interface for the MVNO to manage their services across the virtual network and serves as a middleware between the services and the communication network and systems.

### CROSS-REFERENCE TO RELATED APPLICATION

This application claims the benefit of U.S. Provisional Applications No. 60/429,434 filed Nov. 29, 2002, “Platform with an interface to develop applications which will operate across various communication networks” by Dorron Mottes, this application is incorporated herein by reference.

### BACKGROUND OF THE INVENTION

Currently, the communication market operators (i.e. mobile, wireline, cable) provide and operate the communication network; on top of it they provide services and applications (i.e. voice mail, conference call), which are provided to their customers.

In order to continue growing the operators will need to focus and select to be either, a network operator or a service provider. The network operators will be large entities because there is an advantage to the size of the operator, enabling them to be more cost effective. This will lead to consolidation across international markets creating large international network providers. Service providers can be of various sizes depending on the market they are targeting. Because service providers will customize and localize their services, most of them will be small or medium size, and many of them won't have communication expertise.

The service providers' expertise and core competencies will be in one or several of the following main fields: Service creation, content management, content creation, customer management, and marketing.

In order for the service providers to provide service they will need a communication platform, which will interface with the various communication networks (i.e. mobile network, Wireless LAN, Wireline network, Internet) and infrastructure from various network operators, and a platform on which they can develop and manage standard and new services.

Some of the service providers will provide communication services as A Mobile Virtual Network Operator (MVNO), a MVNO can be defined as an organization that offers mobile subscription and call services to customers but does not have an allocation of spectrum.

The following are the main reasons for the creation of the MVNO market:

Network operators must increase their revenues and recover their expenses. In order to accomplish the growth they need to generate more traffic and provide added value services and applications.

Network operators can enter the mobile market instantly by becoming a MVNO, with no need to invest in spectrum allocation and developing the network, in the areas they become MVNOs, enabling them to provide bundled communication services (i.e. wireline telephony, broadband, wireless) and provide service across borders.

Mobile network operators cannot develop and support all the types of 2.5G/3G applications and services. Imagine that all websites and services on the Internet would have been created by the network operators (i.e. MCI, AT&T, Sprint BT) instead of companies such as eBay, Yahoo, Amazon.

Network operators lack the knowledge and the resources for developing many new and data based applications and services.

Deregulation in Europe and the US is opening the market for service providers without a network. Regulators are forcing operators to open their networks.

Once some network operators open their networks to MVNOs, other network operators will be forced to open their networks to MVNOs, otherwise they will lose traffic.

More entities will want to become MVNOs. These entities will need an open system which enables them to develop and manage standard applications and services across a virtual network. The System serves as a middleware between the services and the communication network and systems (i.e. wireless network, wireless LAN hot spots, Internet, wireline, Mobile Switching Center (MSC), Home Location Register (HLR), EIR, Visitor Location Register (VLR), prepaid systems), thus freeing the MVNOs from allocating resources for establishing and operating a complex and expensive communication infrastructure, and enable them to focus on building the business logic and their core competencies.

### SUMMARY OF THE INVENTION

It is an object of the present invention to provide a method and system, for a hosted MVNO platform and management solution, which enables a MVNO to develop and manage applications and services across a virtual network serving as a middleware between the services and the communication infrastructure (i.e. network, communication systems). This invention frees the MVNOs from allocating resources for establishing and operating a complex and expensive communication infrastructure, enabling them to focus on building the business logic and their core competencies. In addition, the system operator will be responsible for reaching agreements with one or more Mobile Network Operators (MNO) and will create a virtual wireless network which will enable MVNOs and service providers to instantly have a virtual wireless network while signing one agreement with the System operator.

An MVNO Application Service Provider (MVNO ASP), which most likely will be a large network operator, or a new entity, will operate and host the System (MVNO ASP System or System or Platform). The System and the MVNO ASP are mediators between the various communication networks, and network operators, to the MVNOs, and the services and applications, which operate across the virtual network.

The System enables a MVNO to develop applications and services, and or provide mobile subscription and or services and or market services to their customers and potential customers, while working with one MVNO ASP System. The System provides an interface for the MVNOs to develop, manage and support the various applications and services. The interface hides the communication infrastructure and takes care of executing the communication related tasks, enabling the MVNO to focus on building the business logic, the applications and services.

The MVNO ASP suppliers are the various communication network operators (i.e. mobile operators, WLAN operators, wireline operators, ISPs, cable operators). The MVNO ASP System will integrate and or communicate with its suppliers network and systems, and will have agreements to buy and or rent capacity and or rent services and or rent systems from the network operators.

The MVNO ASP customers are various MVNOs and service providers, which market under their name, mobile subscription and or mobile services, which are based on the MVNO ASP virtual wireless network and services. The MVNO ASP provides MVNOs with access to the System and sells and or rents to them various network capacity and communication services, such as mobile minutes, bandwidth rental, content and service rent.

As an example the System enables a MVNO, such as Yahoo, to focus on their customers, while expanding their services to the wireless world, creating new services and cross platform services, which operate across various networks, and freeing them from the need to learn and develop the communication infrastructure which will be provided by a MVNO ASP.

The System enables a MVNO aggregator and or owner of several MVNOs and or manager of several MVNO (Multi MVNO Aggregator) to centrally define and manage several MVNOs. These MVNOs do not have a carrier ID, are defined as software MVNOs, and are associated with the Multi MVNO Aggregator, which defined them (in cases a Multi MVNO Aggregator does not have a Carrier ID they are associated with the MVNO ASP). The entity, which these MVNOs are associated with, is responsible for all their interaction with the MNO and or other network operators, these entities must have a table which links each MVNO user to the MVNO they belong to based on a unique key such as the User ID.

As an example, the System enables a Multi MVNO Aggregator such as a recording company to manage several MVNOs, each MVNO could be a different singer or group (i.e. a Madona MVNO, an Eminem MVNO), and each MVNO can have its unique content and interface. The Multi MVNO Aggregator defines via the System new virtual MVNOs, defines the interface to End Users, the unique content, and shared content (syndicated content which are accessed by several MVNOs). The Multi MVNO Aggregator then has the ability to manage its customers centrally and enables them to switch MVNOs instantly or add additional MVNOs to their subscription.

The MVNO ASP will treat the Multi MVNO Aggregator as a MVNO with a permission to create virtual software MVNOs. The End user will select the virtual MVNO service they would like (i.e. the Eminem MVNO service), and from the End User point of view they are using a regular mobile operator.

Each time the End User uses the service, the MVNO ASP identifies the user as a Multi MVNO Aggregator user and will access the Multi MVNO database to identify which virtual MVNO they subscribe to, and then present the relevant interface and content.

The main advantages for a MVNO and Service Providers to use the MVNO ASP and to use the MVNO ASP Platform are:

MVNOs and service providers can focus on their current business and core competencies. MVNO ASP takes care of all communication infrastructure, Platform operations, customer provisioning, in addition the MVNO ASP together with its partner network can take care of application and service development, billing, customer care, distribution, marketing consulting;

Faster time to market at lower up-front costs;

No need to invest in an expensive communication infrastructure;

MVNO ASP can offer an International foot print;

Because of the open nature of the System many developers, other service providers and MVNOs and the MVNO ASP will develop many value added services on top of the System; MVNOs and service providers can offer these services to their companies too (most likely they will have to license rent or pay a fee for using these services and applications, however they will be available immediately with no need for additional development);

Enables MVNOs and service providers to develop cross-product and cross services promotions and develop creative pricing;

MVNOs and service providers do not need to develop partnerships and agreements with network operators; and

Small to medium size entities can enter the MVNO and service provider market (They could not do that before because of the capital investment and lack of knowledge and resources); Larger entities can decide if they would like to develop to invest in learning and acquiring the knowledge and then develop an expensive proprietary solution or they prefer to outsource an open and standard platform.

### BRIEF DESCRIPTION OF THE DRAWINGS

The present invention will be further understood and appreciated from the following detailed description taken in conjunction with the drawings in which:

FIG. 1 is a block diagram illustration of one embodiment of the invention, in which a MVNO ASP platform is described.

FIG. 2 is an architecture diagram illustration of one embodiment of the invention.

FIG. 3 is an architecture diagram illustration of one embodiment of the invention, in which the MVNO ASP operation includes switching capabilities

FIG. 4 is a value chain diagram of one embodiment of the invention, the MVNO value chain.

In FIG. 5 there is shown an architecture diagram illustration of one embodiment of the invention, in which Multi MVNO Aggregator, manages several MVNOs.

In FIG. 6 there is shown a workflow illustration of one embodiment of the invention, of a mobile user network registration and authentication process.

In FIG. 7 there is shown a workflow illustration of one embodiment of the invention, of an inbound voice call to a MVNO mobile user which their MVNO is hosted by a MVNO ASP, this example is based on a GSM network.

In FIG. 8 there is shown a workflow illustration of one embodiment of the invention, of an outbound voice call from a MVNO mobile user which their MVNO is hosted by a MVNO ASP, this example is based on a GSM network.

### DETAILED DESCRIPTION OF THE INVENTION

It is an object of the present invention to provide a method and system, for a hosted MVNO platform and management solution, which enables a MVNO to develop and manage applications and services across a virtual network serving as a middleware between the services and the communication network and systems. This invention frees the MVNOs from allocating resources for establishing and operating a complex and expensive communication infrastructure, enabling them to focus on building the business logic and their core competencies. In addition, the system operator will be responsible for reaching agreements with one or more Mobile Network Operators (MNO) and will create a virtual wireless network which will enable MVNOs and service providers to instantly have a virtual wireless network while signing one agreement with the system operator.

An MVNO Application Service Provider (MVNO ASP), which most likely will be a large network operator, or a new entity, will operate and host the System (MVNO ASP System or System). The System and the MVNO ASP are mediators between the various communication networks, and network operators, to the MVNOs, and the services and applications, which operate across the virtual network.

The System enables a MVNO to develop applications and services, and or provide mobile subscription and or services and or market services to their customers and potential customers, while working with one MVNO ASP System. The System provides an interface for the MVNOs to develop, manage and support the various applications and services. The interface hides the communication infrastructure and takes care of executing the communication related tasks, enabling the MVNO to focus on building the business logic, the applications and services.

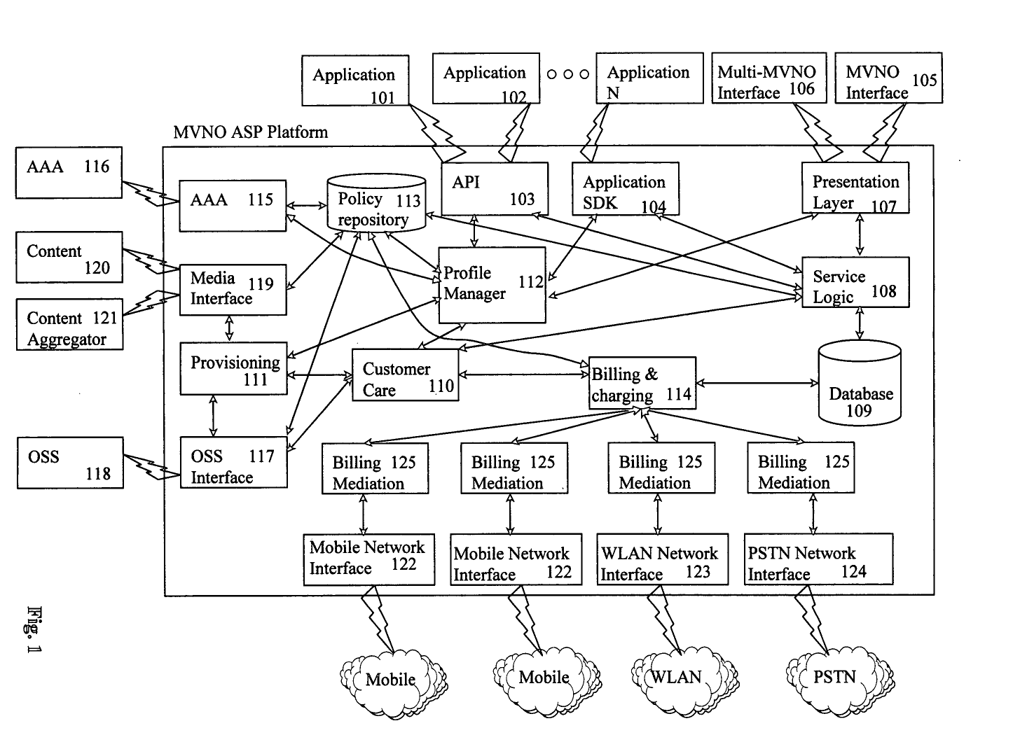

In FIG. 1 there is shown a block diagram illustration of one embodiment of the invention, of a MVNO ASP Platform.

The MVNOs and or service providers can use pre-defined applications (101) or can develop or work with a developer or license and or rent and or purchase from a developer a new application (102). The application can be developed and interact with the MVNO ASP Platform via an API (103) or an application Service Development Kit (SDK) (104) which may include a graphical interface. The SDK can include testing debugging tools.

The service logic is stored and can be changed via the API or application SDK, the End User can manage and support his/her application via an MVNO interface (105) and the Multi MVNO Aggregator can manage and support its applications and MVNOs via a Multi MVNO interface (106), both interfaces are part of the presentation layer of the system (107). All applications business logic is stored in the service logic servers (108). All data is stored in the system database (109). The MVNO applications can be stored with the MVNO ASP or can be stored anywhere else and interact with the MVNO ASP Platform.

The system is fully partitioned enabling each MVNO and or service provider to set its own customers, set its own provisioning and permissioning, and manage and maintain its applications. The information is managed by the MVNO ASP via the customer care module (110) which maintains customer care information, which can include data such as, MVNO and or service provider information, billing plans, and data regarding each MVNO and or service provider customers; the provisioning of new users including new MVNO, new MVNO customers, new MVNO group customers and the services they can access are managed via the provisioning module (111) and the Profile Manager (112).

In cases were the MVNO does not have a carrier ID and or is a software MVNO, the profile manager module includes a table, which maps each user to the MVNO it uses, enabling the MVNO ASP, to identify the MVNO that is providing service to a user. In these cases the MNO identifies the user as a MVNO ASP user, and the MVNO ASP is responsible for identifying the MVNO based on the above table.

The policy management and policy repository (113) are the focal point for authorizing users of the system access to resources, policy repository is built from data it retrieves from internal systems such as profile manager, charging module and external systems such as a mobile operator Operation Support System (OSS). Services such as, billing information, billing plans, charging, partner agreements order fulfillment and rating are gathered and maintained via the billing and charging module (114).

The Authentication Authorization Accounting system (AAA) (115) is the point of contact for authenticating, authorizing and accounting of users, it access modules such as the policy repository and the profile manager, and in some cases it will request external AAA systems (116) to provide the authentication and or authorization and or accounting (i.e. AAA system operated by the MVNO).

The system can interface (117) with external OSS (118) both for MVNO ASP operations and for the MVNOs and service providers OSS. Access to external content is managed via the media interface (119) and can be received via content provider (120) or content aggregator (121). The system interfaces with various networks such as, Mobile network (122) Wireless LAN (WLAN) (123) Public Switched Telephone Network (PSTN) (124), the system can interface with many networks from each type for example an MVNO ASP can interface with many mobile operators, each one can have its own agreement, with its own capacity, and pricing. The billing mediation module (125) collects the data from the various network interfaces and all data is aggregated by the billing module in order to enable payment to suppliers and creating bills for the MVNO and service providers and creating bills for the MVNO and service providers' customers.

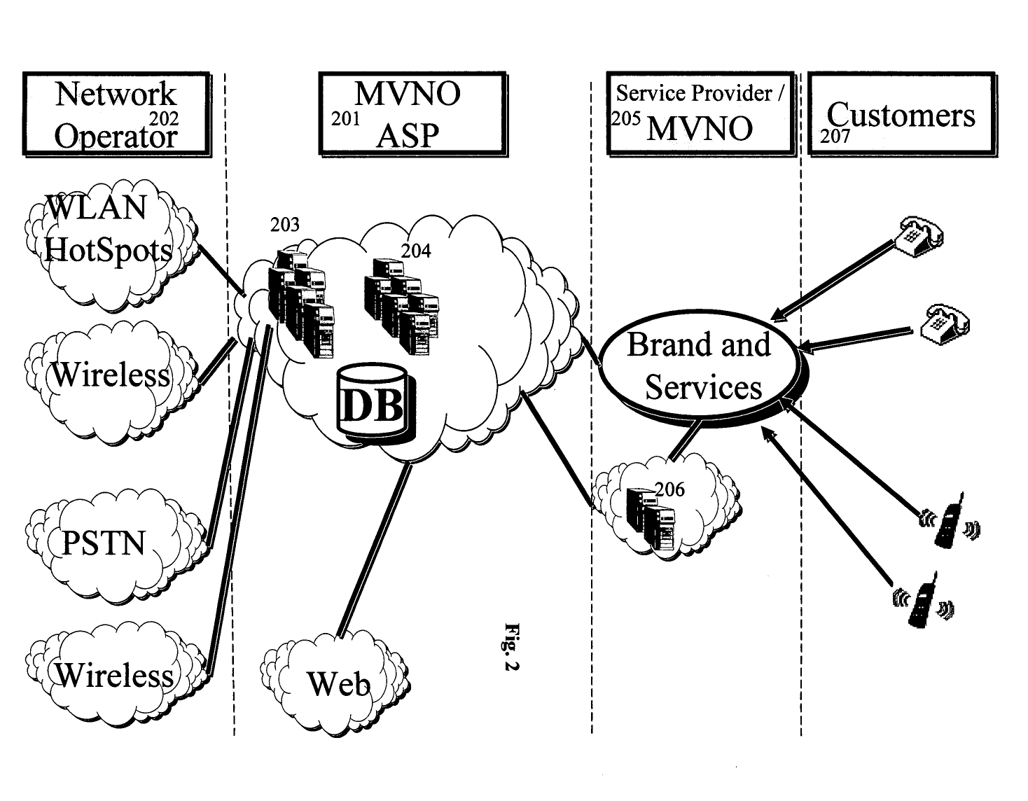

In FIG. 2 there is shown an architecture diagram illustration of one embodiment of the invention.

The MVNO ASP (201) develops partnerships with the various network operators (202) including WLAN operators, Wireless operators, PSTN operators, and Internet Service Providers (ISP). The MVNO ASP operates and maintains the MVNO ASP Platform (203), which manages, among other tasks, the partnership module and operators settlement fees. The MVNO ASP hosts various applications (204) including applications developed by MVNO ASP, by independent developers, MVNOs and service providers. MVNO and service providers (205) can host their applications with other ASPs (206) and the applications will interact with the MVNO ASP.

MVNO and service provider's customers (207) access the services provided by the MVNO and service providers, which “owns” the customer relationship, and is responsible for the service. The MVNO customer does not need to know nor have relationships with the MVNO ASP, and or any of the mobile network operators, which handles the calls and or with any other partners and developers which are part of the MVNO ASP network.

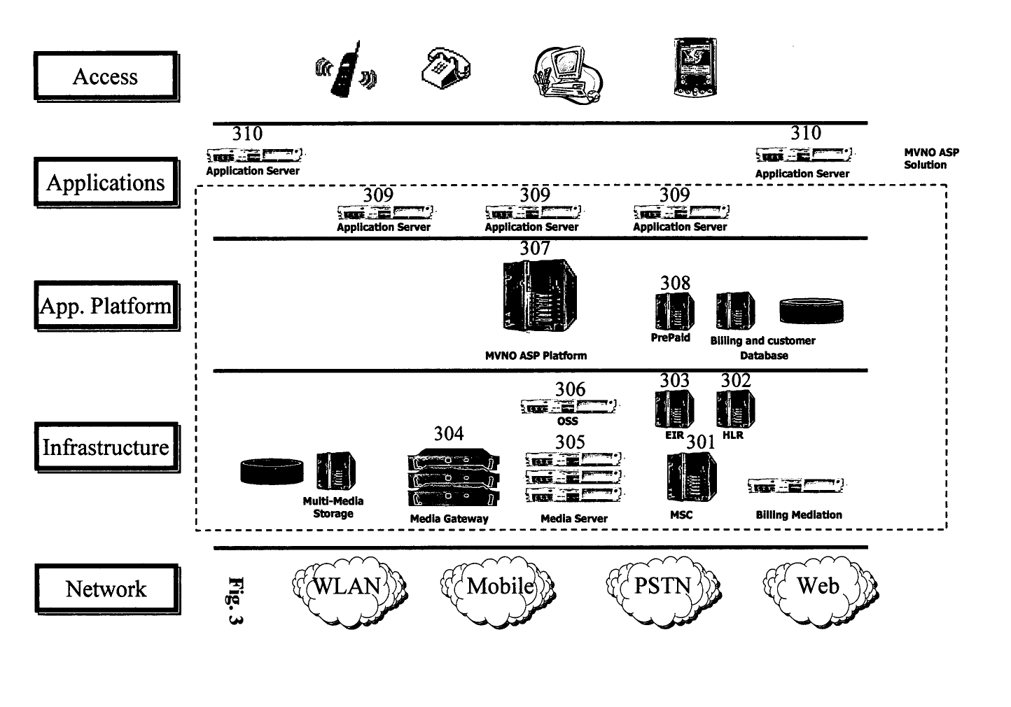

In FIG. 3 there is shown an architecture diagram illustration of one embodiment of the invention, in which the MVNO ASP operation, includes switching capabilities. The MVNO ASP operates its own switch (301) Home Location Register (HLR) (302) EIR (303) and other communication servers such as Media Gateway (304) Media Servers (305) and operates its own OSS (306).

The MVNO ASP Platform (307) interacts with the MVNO ASP communication infrastructure as well as with other operator infrastructure.

The MVNO ASP can provide a prepaid solution (308), which will enable MVNO to offer such a service to their customers.

The MVNO ASP can provide core applications and standard applications (309) as part of the solution offered to MVNOs, applications such as, voice mail, unified messaging, SMS, conferencing etc.

Because the MVNO ASP Platform is an open system with standard and or documented interfaces, MVNOs, service providers and independent developers can create additional applications (310), these applications can be marketed and or operated by their creators and in some cases can become an additional application which is offered to all other MVNOs and service providers (most likely there will be a price tag for using the application).

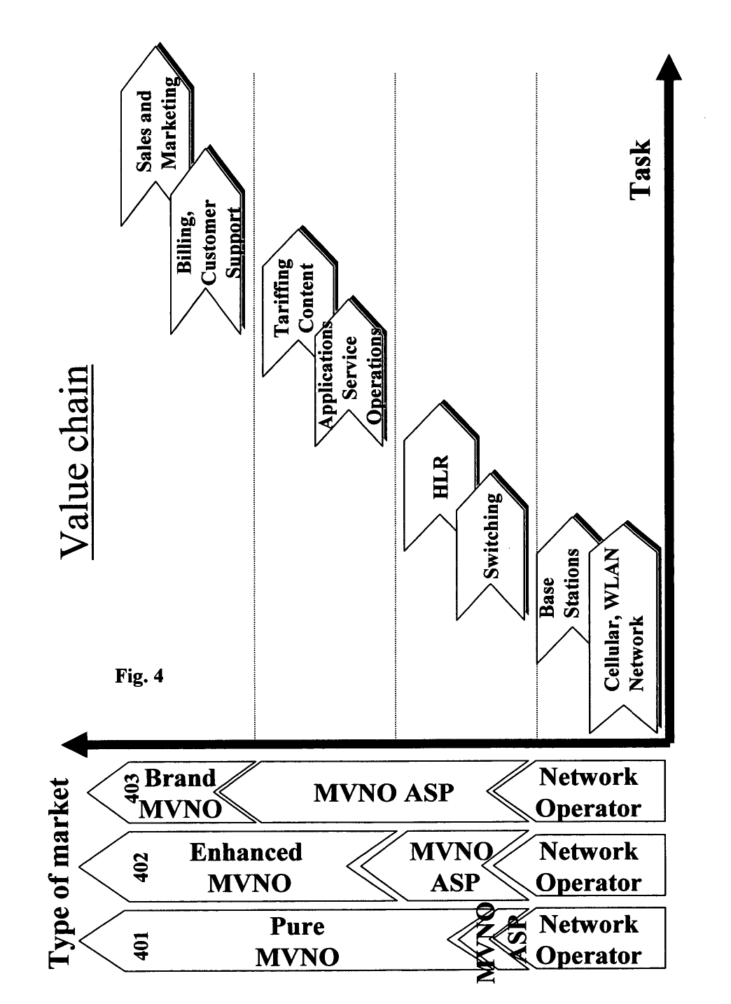

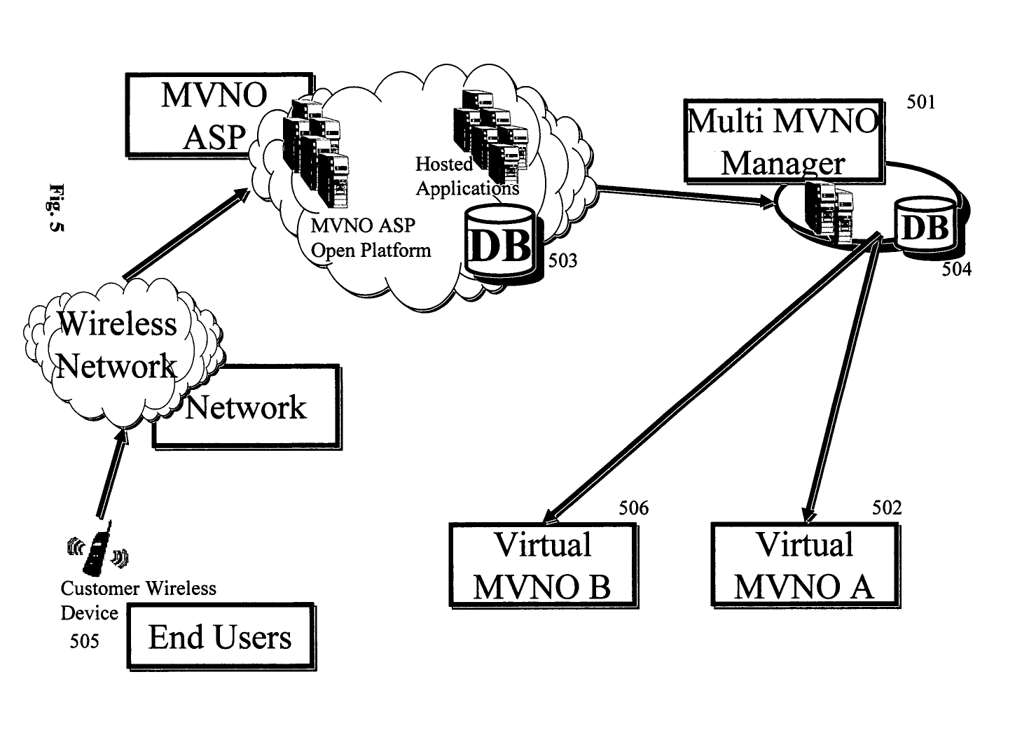

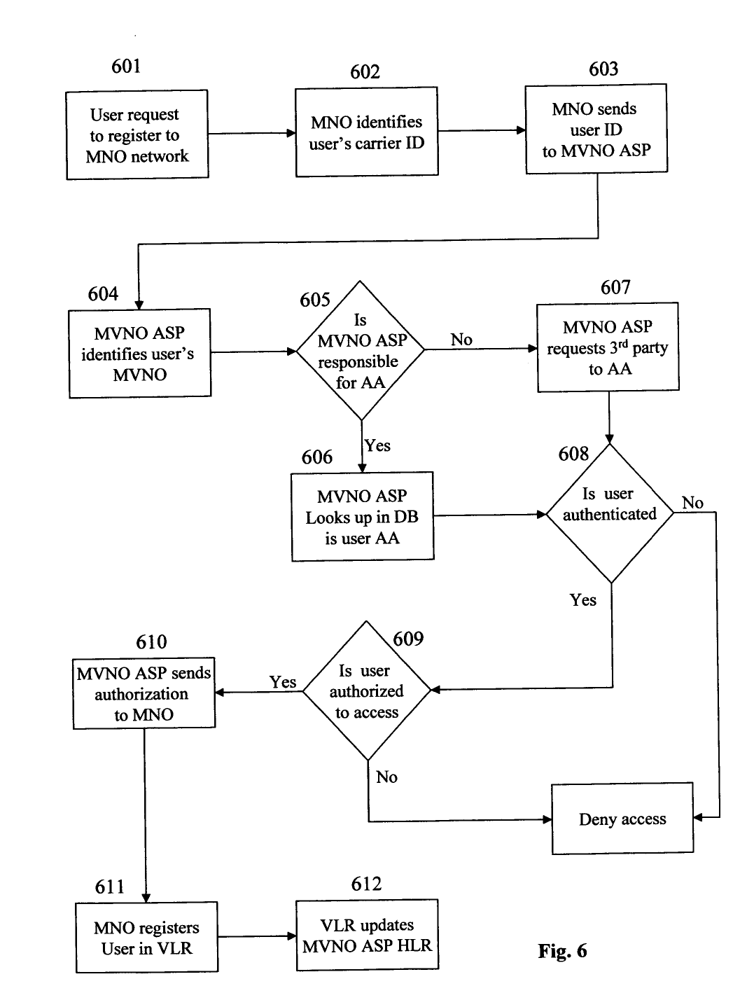

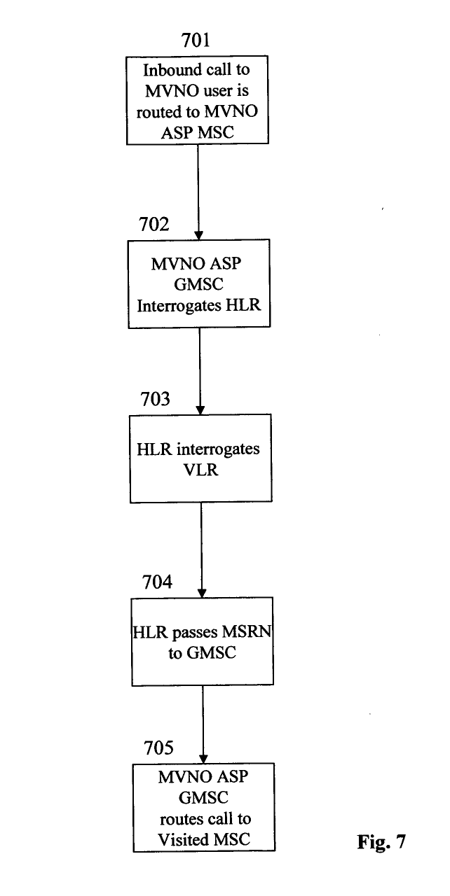

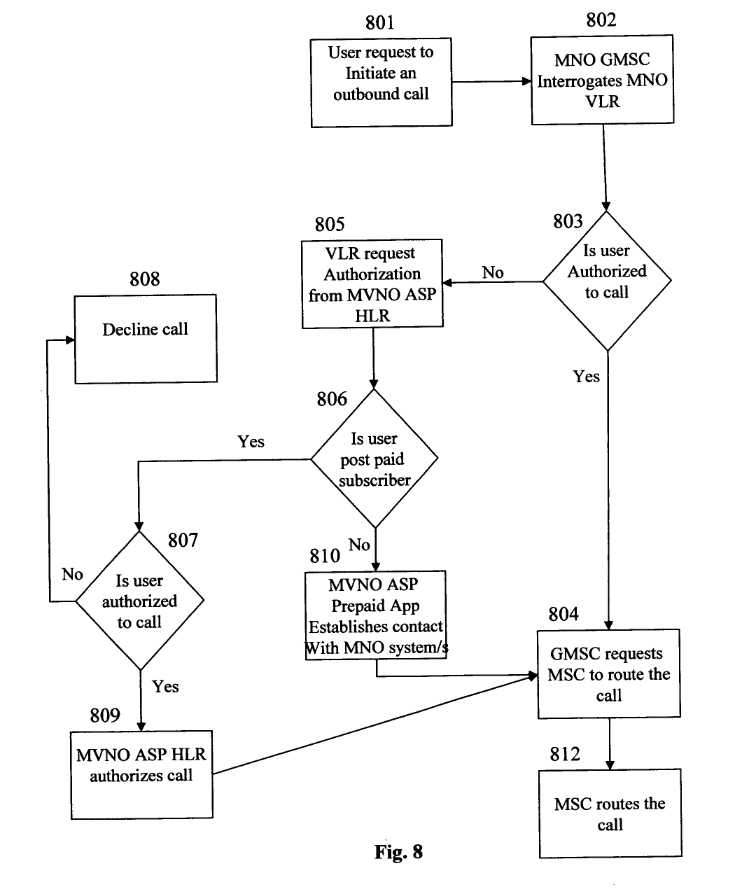

In FIG. 4 there is shown a value chain diagram of one embodiment of the invention, the MVNO value chain. This diagram describes the tasks a MVNO ASP will be responsible for in each type of MVNO customer.

The MVNO value chain consists of the following activities:

Cellular network and base stations; switching and routing of calls; service operation of network elements; tariffing; billing; customer support; and marketing.

A Pure MVNO (401) takes on all the above activities except for providing the cellular network and base stations, it will have its own Switching and or HLR. In this case the MVNO ASP will be responsible for tasks such as, managing all partnerships with the various network operators and providing one virtual network and services, and an application development infrastructure.

An Enhanced MVNO (402) can have all or none of the network elements and takes on the tariffing & billing, customer support and marketing activities. In this case the MVNO ASP will provide the communication infrastructure and services, and an application development infrastructure.

The Brand MVNO (403) outsources all the network elements and handles only selected parts of billing and or customer support and or marketing. In this case the MVNO ASP will provide a full communication infrastructure and most of the operational tasks, enabling the MVNO to focus on tasks, which it specializes, such as, brand, marketing, and customer care.

In FIG. 5 there is shown an architecture diagram illustration of one embodiment of the invention, in which Multi MVNO Aggregator, manages several MVNOs.

A Multi MVNO Aggregator (501) defines a new Virtual MVNO (502) the data regarding the Virtual MVNO A are stored in a database which can be hosted by the MVNO ASP (503) or in other locations (504). The Multi MVNO Manger will define parameters and services such as: name of Virtual MVNO, customer interface, services, billing plans, devices which can access this service, End User which can access this service, etc. End Users (505), which join the service are authenticated as the Multi MVNO Aggregator users, and then are looked up in the Multi MVNO Aggregator database in order to match them to the virtual MVNO/s they are subscribed to. Based on their authorization and the services they are subscribed, the proper interface will be presented to them, and enable them to access the service/s they are authorized to access.

A Multi MVNO Aggregator can create and manage several virtual MVNO (506), each one with their own price plan, own services, own content and own End Users. They can create shared content, which will be shared between the selected virtual MVNOs they select. End Users can subscribe to more then one service, including services provided by 3^{rd} party service providers, which offer their service over the MVNO ASP infrastructure.

Based on the Multi MVNO Aggregator definitions, customers can change their main virtual MVNO via a web interface or over the air via the wireless device.

In FIG. 6 there is shown a workflow illustration of one embodiment of the invention, of a mobile user network registration and authentication process.

A user and or a device try to register to the Mobile Network Operator (MNO) network (601) the user and or device provide the MNO with user ID and or device ID (i.e. mobile subscriber identity number (MSIN) in a GSM network) and the carrier ID (i.e. Mobile Network Code (MNC) in a GSM network). The MNO identifies that the user and or device are not a MNO user and or device and identifies their carrier based on the carrier ID (602).

The MNO sends a request to the carrier which matches the carrier ID, to authenticate the user and or device (603) in this example the are two main options; the carrier ID matches the MVNO ASP carrier ID (in cases were the MVNO ASP is the one issuing the SIM card on behalf of the MVNO) or the carrier ID is associated with the MVNO ASP (in the cases were the MVNO or the Multi MVNO Aggregator have their own carrier ID).

In both above options the MVNO ASP identifies the MVNO associated with the user, which is requesting to register to the network (604). One of the main options to identify the user's MVNO, is to look up in the “user ID-MVNO” table, which includes a list of all the various MVNO users and the MVNOs they are associated with.

The MVNO ASP looks up if it is responsible for authentication and authorization for this MVNO (605), in most cases the MVNO ASP Authentication Authorization and Accounting server (AAA server) will manage this process (606). If MVNO ASP is not responsible for authentication and authorization the AAA server will look up who is the party, which is responsible for authentication and authorization (i.e. Multi MVNO Aggregator, MVNO) and will send to their AAA server the request (607). If MVNO ASP AAA server is responsible for the process it will lookup the user ID. In both cases, if additional identification is needed (i.e. password) the AAA Server responsible for the process will request such data from user.

Once user is authenticated (608), the AAA Server will look up if the user is authorized to register to the network and receive any limits or rules regarding the user (609). If user is authorized the MVNO ASP authorize the MNO to register the user, the authorization message can include any limitations or rules regarding the user (additional data will be sent based on the support of the MNO systems of these type of features)(610). MNO will register user to network and will register the user in its Visitor Location Register (VLR) (611). The VLR notifies the MVNO ASP HLR, which updates and or creates a record of the last VLR to update the position of the user (612).

In FIG. 7 there is shown a workflow illustration of one embodiment of the invention, of an inbound voice call to a MVNO mobile user, which their MVNO is hosted by a MVNO ASP, this example is based on a GSM network.

An inbound call is routed by the PSTN network using the PSTN number to the MVNO Gateway Mobile Switching Center (GMSC) (701). The MVNO ASP GMSC then interrogates the MVNO ASP HLR (702) The MVNO ASP HLR has a translation table to convert the PSTN number to the International Mobile Station Identity (IMSI) number used by the GSM networks. The MVNO ASP HLR will have a record of the last VLR to update the position of the subscriber (or if the subscriber is attached to the network).

The MVNO ASP HLR interrogates the VLR (703), which responds with the Mobile Station Roaming Number (MSRN) for routing. That is the information needed by the MVNO ASP Gateway Mobile Switching Center (GMSC) to route the call. The MVNO ASP HLR then passes the MSRN to the MVNO ASP GMSC (704), which routes the call to the visited Mobile Switching Center (MSC) (705) (in some cases the MVNO ASP GMSC will use the MSRN to route the call through the PSTN).

In FIG. 8 there is shown a workflow illustration of one embodiment of the invention, of an outbound voice call from a MVNO mobile user, which their MVNO is hosted by a MVNO ASP, this example is based on a GSM network.

MVNO User requests to initiate an outbound call (801). The MNO GMSC interrogates the MNO VLR (802). If MNO VLR authorized the subscriber (803) the GMSC requests to route the call (804).

If MNO VLR has no automatic authorization, it needs to contact the MVNO ASP HLR to request authorization (805). If the user is a MVNO post paid subscriber (806) the HLR will check if the user is authorized for such a call and are there any limits to such a call (807). In many cases the MVNO ASP HLR will be able to provide authorization, however in some cases the HLR will require the MVNO ASP Authentication Authorization and Accounting system (AAA) to provide the answer, which in some cases the MVNO ASP AAA will communicate with the MVNO AAA system in order to fetch the authorization. If the user is not authorized a message will be sent to MNO to decline the call (808).

If the user is authorized the MVNO ASP HLR will authorize the call and provide the MNO GMSC with the authorization and any limitations on the call (based on the MNO support for such limits) (809).

If the user is a MVNO prepaid subscriber (806), then the MVNO ASP prepaid system will establish a connection with the MNO relevant system or systems (810) (depends on the MNO, it could be system such as the MNO prepaid system, MNO GMSC, MNO MSC), and then will authorize the call and will continue to monitor the call, for example it will request to disconnect the call if prepaid account is empty.

In both cases, prepaid and postpaid, the GMSC requests the MSC to route the call (811). The MVNO ASP can require to route the call via the MVNO ASP MSC, in cases the MVNO ASP does not request a special route the MNO will route the call based on its routing tables. Based on the GMSC request and instructions the MSC will route the call (812).

It will be appreciated that the invention is not limited to what has been shown and described hereinabove. Rather, the scope of the invention is limited solely by the claims that follow.

1. A method in which Entity A (i.e. MVNO ASP) develops an agreement with at least one Mobile Network Operator (MNO) enabling Entity A to use the MNO network to provide a virtual network offering, which it offers to Entity B (i.e. MVNO, service provider). Entity B offers mobile service to its users under an Entity B name, based on Entity A's virtual network and does not have an allocation of spectrum in the areas it offers Entity A's virtual network.

2. A method according to claim 1 and further comprising, in which Entity A uses at least one of the MNO services which are integrated to Entity A's virtual network offering.

3. A method according to claim 1 and further comprising, in which Entity A develops an agreement with at least one wireline operator enabling Entity A to use part of the wireline operator's network and services, and integrate it into Entity A's virtual network offering.

4. A method according to claim 1 and further comprising, in which Entity A develops an agreement with at least one cable operator enabling Entity A to use part of the cable operator's network and services, and integrate it into Entity A's virtual network offering.

5. A method according to claim 1 and further comprising, in which Entity A develops an agreement with at least one satellite operator enabling Entity A to use part of the satellite operator's network and services, and integrate it into Entity A's virtual network offering.

6. A method according to claim 1 and further comprising, in which Entity A develops an agreement with at least one communication aggregator network enabling Entity A to use part of the communication aggregator's network and services, and integrate it into Entity A's virtual network offering.

7. A method according to claim 1 and further comprising, in which Entity B integrates Entity A's virtual network with other networks and services Entity B offers.

8. A method according to claim 1 and further comprising, in which Entity B markets services under an Entity B name to their users and potential users based on a system provided by Entity A.

9. A method according to claim 1 and further comprising, in which Entity B markets services under an Entity B name to their users and potential users based on a service provided by Entity A.

10. A method according to claim 1 and further comprising, in which Entity B develops services based on Entity A infrastructure, and are hosted by Entity A, and markets these services under an Entity B name to their users and potential users.

11. A method according to claim 1 and further comprising, in which Entity B has no carrier ID on the MNO network, Entity B users use Entity A's carrier ID, and Entity A is responsible for identifying the user as an Entity B user.

12. A method according to claim 11 and further comprising, in which Entity A is responsible for identifying the Mobile Virtual Network Operator (MVNO) carrier based on MVNO user information.

13. A method according to claim 1 and further comprising, in which Entity A operates an HLR, which includes Entity B users' information.

14. A method according to claim 1 and further comprising, in which Entity A operates an MSC.

15. A method according to claim 1 and further comprising, in which Entity A operates a prepaid solution, which Entity B prepaid users' use.

16. A method according to claim 15 and further comprising, in which Entity A prepaid solution, interacts with MNO systems in order to monitor and control the call based on the prepaid solution rules and prepaid account money reserves.

17. A method according to claim 1 and further comprising, in which Entity A operates an authentication mechanism and is responsible for authenticating Entity B users.

18. A method according to claim 17 and further comprising, in which the authentication mechanism is an AAA server.

19. A method according to claim 18 and further comprising, in which the AAA server communicates with Entity B AAA server in order to authenticate Entity B users.

20. A method according to claim 1 and further comprising, in which Entity A operates an authorization mechanism and is responsible for authorizing Entity B users to access the network and services.

21. A method according to claim 20 and further comprising, in which the user authorization data is cached for future authorization requests.

22. A method according to claim 20 and further comprising, in which the authorization mechanism is an AAA server.

23. A method according to claim 21 and further comprising, in which the AAA server communicates with Entity B AAA server in order to authorize Entity B users.

24. A method according to claim 1 and further comprising, in which Entity A provides Entity B's users with a bill on behalf of Entity B and under an Entity B name.

25. A method according to claim 1 and further comprising, in which Entity A provides Entity B's users with customer care services on behalf of Entity B.

26. A method according to claim 1 and further comprising, in which Entity A aggregates content, and enables Entity B to resell content services based on Entity A aggregated content to Entity B users under an Entity B name.

27. A method according to claim 1 and further comprising, in which Entity A operates and manages applications which were developed by Entity B and third party entities.

28. A method according to claim 1 and further comprising, in which Entity A prices its services based on the content and not based on the transport of data over the network.

29. A method in which Entity C is an aggregator of MVNOs; Entity C MVNOs do not have a MNO carrier ID and are defined via software; Entity C is responsible for defining new MVNOs, including the definition of the applications and services which each MVNO will include; Entity C MVNO user is identified as an Entity C user, and Entity C is responsible for identifying the user as an Entity C MVNO user;

30. A method in which Entity A (i.e. MVNO ASP) develops agreements with at least one MNO enabling Entity A to use the MNO network to provide a virtual network offering, which it offers to Entity C (i.e. Multi MVNO Aggregator). Entity C is an aggregator of MVNOs; Entity C MVNOs do not have a MNO carrier ID and are defined via software; each MVNO offers mobile service to its users, based on Entity A's virtual network and does not have an allocation of spectrum in the areas it offers Entity A's virtual network; Entity C does not have an allocation of spectrum in the areas it offers Entity A's virtual network.

31. A method according to claim 30 and further comprising, in which Entity A virtual network offering, includes other communication operators networks and services.

32. A method according to claim 30 and further comprising, in which Entity A operates an HLR, which includes Entity C MVNO users' information.

33. A method according to claim 30 and further comprising, in which an Entity C MVNO users are identified as an Entity A user, and Entity A is responsible for identifying the user as a Entity C MVNO user.

34. A method according to claim 30 and further comprising, in which Entity A operates an authentication mechanism and is responsible for authenticating Entity C MVNO users.

35. A method according to claim 34 and further comprising, in which the authentication mechanism is an AAA server.

36. A method according to claim 35 and further comprising, in which the AAA server communicates with Entity C AAA server in order to authenticate Entity C MVNO users.

37. A method according to claim 30 and further comprising, in which Entity A operates an authorization mechanism and is responsible for authorizing Entity C MVNO users to access the network and services.

38. A method according to claim 37 and further comprising, in which the user authorization data is cached for future authorization requests.

39. A method according to claim 37 and further comprising, in which the authorization mechanism is an AAA server.

40. A method according to claim 39 and further comprising, in which the AAA server communicates with Entity C AAA server in order to authorize Entity C MVNO users.

41. A method according to claim 30 and further comprising, in which Entity A provides Entity C's MVNO users with a bill on behalf of the MVNO, and under the MVNO name.

42. A method according to claim 30 and further comprising, in which Entity A provides Entity C's MVNO users with customer care services on behalf of the MVNO.

43. A method according to claim 30 and further comprising, in which Entity A aggregates content, and enables Entity C to resell content services based on Entity A aggregated content to Entity C MVNO customers under Entity C MVNO brand name.

44. A method according to claim 30 and further comprising, in which Entity A operates a prepaid solution, which Entity C MVNO prepaid users' use.

45. A method according to claim 44 and further comprising, in which Entity A prepaid solution, interacts with MNO systems in order to monitor and control the call based on the prepaid solution rules and prepaid account money reserves.

46. A hosted system providing a Mobile Virtual Network Operator (MVNO) the ability to offer mobile service to its users over a virtual wireless network, which is based on at least one Mobile Network Operator (MNO) network. The system can host more then one MVNO, each MVNO has it own partitioned part of the system, comprising: a software component for managing and configuring services, a component which interacts with MNO network, a software mediation engine which handles the service and application communication between the software and application management system and the software and hardware components which interact with the MNO network.

47. A system according to claim 46 and further comprising, in which the system interacts with at least one of the MNO systems.

48. A system according to claim 46 and further comprising, in which the system interacts with other external networks and services, and provide a platform for defining and managing services which operate across the various types of networks which are part of the Virtual Network Operator (VNO) offering.

49. A system according to claim 46 and further comprising, in which the system includes an application platform, which hosts applications which are used by MVNO users.

50. A system according to claim 46 and further comprising, in which the system includes a software system for development of services. These services are capable to operate across the virtual network, the system provides notes if there are any limitations for the service operations across parts of the virtual network.

51. A system according to claim 50 and further comprising, in which the system provides suggestions for service configuration and service development, in order to improve service operations, based on the limitation notes.

52. A system according to claim 46 and further comprising, in which the system stores pre-arrangements of use of the network, between the various MNOs, the system operator (i.e. MVNO ASP), and the various MVNOs.

53. A system according to claim 46 and further comprising, in which the system handles the settlement fees between the various network operators, the system operator and the various MVNOs.

54. A system according to claim 46 and further comprising, in which each MVNO has no access to other entity's data, unless the system operator (i.e. MVNO ASP) makes such provision.

55. A system according to claim 46 and further comprising, in which the system provides a MVNO interface, which enables each MVNO to configure and edit their own services and data and define their users' policies and permissioning.

56. A system according to claim 46 and further comprising, in which the system provides a MVNO End User interface, which enables MVNOs' users to register to services, define their preferences and edit their selections and profile.

57. A system according to claim 46 and further comprising, in which the system includes a table, which maps each MVNO End User to the MVNO it uses.

58. A system according to claim 57 and further comprising, in which the unique key of the table is the mobile user ID.

59. A system according to claim 46 and further comprising, in which the system provides a Multi MVNO Aggregator interface, which enables the system operator to associate services and applications to each MVNO, to register to services, define their preferences and edit their selections and profile.

60. A system according to claim 46 and further comprising, in which MVNOs are added to a group, which is managed by an authorized user.

61. A system providing an Entity C to manage at least two software MVNOs, were each MVNO has its own name, and the system enables Entity C (i.e. Multi MVNO Aggregator) to define and manage each MVNO, and its services and its users, comprising: a software component for managing services, a software component for defining and managing a MVNO; a software component for managing the customers of each MVNO; a software component for managing user policies and permissioning; a table, which maps each MVNO End User to the MVNO it belongs to.

62. A system according to claim 61 and further comprising, in which the system interacts with other external networks and services.

63. A system according to claim 61 and further comprising, in which the system provides an MVNO End User interface, which enables MVNOs' users to register to services, define their preferences and edit their selections and profile.

64. A system according to claim 61 and further comprising, in which the system includes a table, which maps each MVNO End User to the MVNO it uses.

65. A system according to claim 61 and further comprising, in which the unique key of the table, which maps each MVNO End User to the MVNO is belongs to, is the mobile user ID.
